(19) United States
(12) Patent Application Publication
(10) Pub. No.: US 2006/0136488 A1
(43) Pub. Date: Jun. 22, 2006

(54) Image forming system, image forming apparatus, information processing apparatus, and recording medium having recorded control program

(75) Inventors: Eiji Mifune, Osaka-shi (JP); Katsushi Horihata, Osaka-shi (JP); Masayoshi Suzuki, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/317,061

(22) Filed: Dec. 22, 2005

(30) Foreign Application Priority Data
Dec. 22, 2004 (JP) 2004-372223

(51) Int. Cl. G06F 7/00; G06F 17/00

(52) U.S. Cl. 707/102

(57) ABSTRACT

An MFP includes a scanner portion; a printing portion, a workflow storage portion that stores workflows, a workflow selection portion that enables a user to select a workflow, a workflow execution control portion that controls the MFP or an PC to execute operations written in the selected workflow, and an MFP execution control portion that controls the scanner portion and the printing portion to operate according to an instruction from the workflow execution control portion. A PC includes an application storage portion that stores programs, an application execution portion that executes programs, and an application execution control portion that controls the application execution portion to execute the programs according to the instruction from the workflow execution portion.

### BACKGROUND OF THE INVENTION

1. Field of the Invention

The present invention relates to an image forming apparatus that forms an image on a recoding sheet, a recording medium having recorded a control program to control operations of the image forming apparatus, an information processing apparatus that executes the program, and an image forming system comprising the image forming apparatus and the information processing apparatus connected to each other via a telecommunication line.

2. Description of the Related Art

When jobs on an image forming apparatus, such as a copying machine, a printer, a scanner device, or an MFP (Multi-Functional Peripherals) furnished with functions of these machines, and jobs on an information processing apparatus, such as a PC (Personal Computer), are performed in series (for example, the document is read by the scanner on the MFP, and the data is OCRed followed by conversion to PDF by the PC, after which the PDF file attached to an e-mail is sent to concerned parties while the PDF file is printed by the MFP), the user has to go to the sites where the MFP and the PC are installed. The user then directly manipulates the image forming apparatus or the information processing apparatus to perform respective operations (for example, image scanning, OCRing, conversion to PDF, e-mailing, printing) one after another.

JP-A-2000-307782 describes a scanner system, in which a scan condition file pre-stored in the scanner device is read on the host computer connected to the scanner device, so that the user is able to select a desired scan condition on the host computer.

The user, however, still needs to go to the sites where the MFP and the PC are installed for a series of operations to be executed by the MFP or the PC. In addition, the user has to manipulate the apparatus for each operation on site. Moreover, even when jobs in the same flow are performed frequently, the user has to manipulate each apparatus every time the flow is repeated.

Also, it should be noted that in the invention described in the reference cited above, a series of operations cannot be carried over from the scanner device (or the MFP) to the PC.

### SUMMARY OF THE INVENTION

The invention was devised to solve the problems discussed above, and therefore has an object to provide an image forming apparatus that enables operations to be executed by both the image forming apparatus and an information processing apparatus to be executed sequentially in the flow with a simple manipulation made on the image forming apparatus, a recoding medium having recorded a control program to control operations of the image forming apparatus, the information processing apparatus, and an image forming system formed of the image forming apparatus and the information processing apparatus connected to each other via a telecommunication line.

More specifically, the invention provides an image forming system including an image forming apparatus and an information processing apparatus connected to each other via a telecommunication line. The image forming apparatus includes: a workflow storage portion that stores workflow information in which types and a sequence of operations to be executed by the image forming apparatus and the information processing apparatus are written; a selection portion that enables a user to select workflow information of one workflow among the workflow information of plural workflows stored in the workflow storage portion; a workflow execution control portion that issues an instruction to each of the image forming apparatus and the information processing apparatus to execute operations written in the workflow information selected by the selection portion; and an image formation execution control portion that controls the image forming apparatus to operate according the instruction from the workflow execution control portion. The information processing apparatus includes: an application storage portion that stores various application programs executable on the information processing apparatus; an application execution portion that executes the application programs stored in the application storage portion; and an application execution control portion that controls the application execution portion to execute the application programs stored in the application storage portion according to the instruction from the workflow execution control portion.

According to the invention, the user selects the workflow information of one workflow among the workflow information of plural workflows stored in the workflow storage portion using the selection portion. Meanwhile, the workflow execution control portion issues an instruction to the image forming apparatus or the information processing apparatus to execute operations to be executed by the image forming apparatus or the information processing apparatus written in the selected workflow information in series. Upon receipt of the instruction, the image formation execution control portion controls the image forming apparatus to exert the functions furnished therewith, whereas the application execution control portion controls the information processing apparatus in such a manner that the application execution portion executes the application programs stored in the application storage portion. The image forming apparatus and the information processing apparatus are thus enabled to execute the flow of a series of operations at a time by merely-giving a simple instruction to the image forming apparatus.

### BRIEF DESCRIPTION OF THE DRAWINGS

FIG. 1 is a block diagram showing the functional configuration of an image forming system according to a first embodiment of the invention.

FIG. 2 is a table showing one example of workflow information according to the first embodiment of the invention.

FIG. 3 is a flowchart detailing the flow of generation and registration of a workflow according to the first embodiment of the invention.

FIG. 4 is a flowchart detailing the flow of execution of the workflow according to the first embodiment of the invention.

FIG. 5 is a block diagram showing the functional configuration of an image forming system according to a second embodiment of the invention.

FIG. 6 is a flowchart detailing the flow of generation and registration of a workflow according to the second embodiment of the invention.

### DETAILED DESCRIPTION OF THE PREFERRED EMBODIMENTS

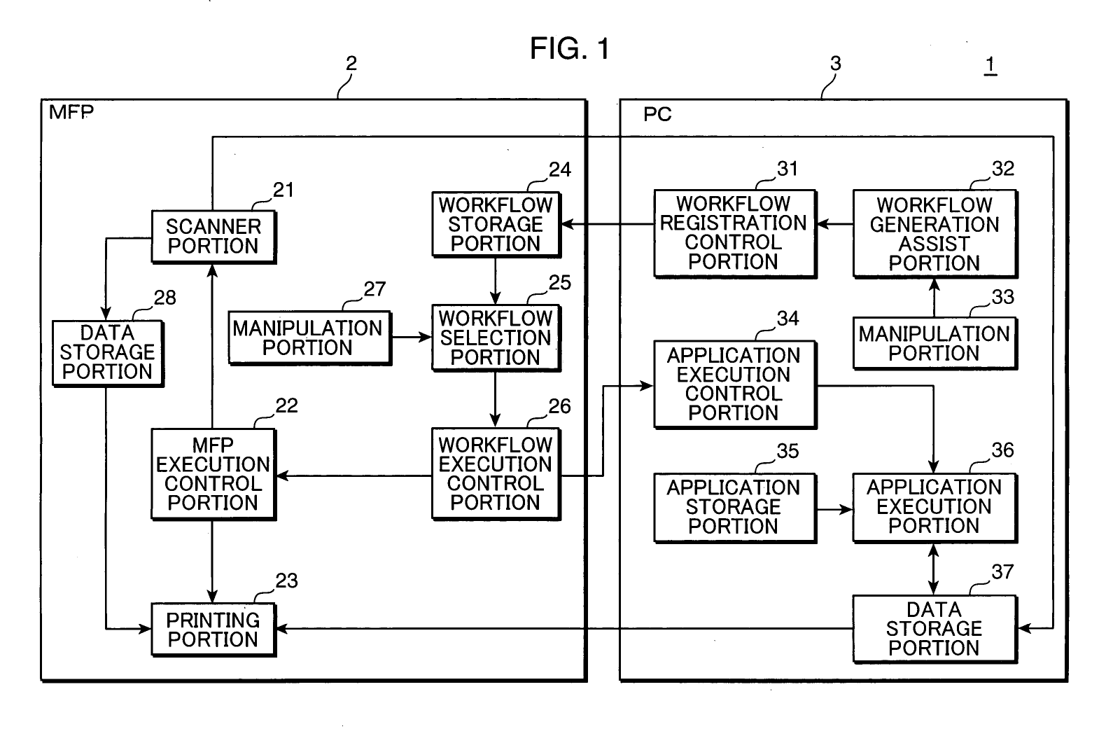

Hereinafter, embodiments of the invention will be described with reference to the accompanying drawings. FIG. 1 is a block diagram showing the functional configuration of an image forming system according to a first embodiment of the invention. An image forming system 1 includes an MFP (Multi-Functional Peripherals) 2 and a PC (Personal Computer) 3 connected to each other to enable communications via a network or the like. The MFP 2 is a digital copying machine furnished with the copying function, the printing function, and the scanning function.

The MFP 2 includes a scanner portion 21, an MFP execution control portion 22, a printing portion 23, a workflow storage portion 24, a work flow selection portion 25, a workflow execution control portion 26, a manipulation portion 27, and a data storage portion 28. The PC 3 includes a workflow registration control portion 31, a workflow generation assist portion 32, a manipulation portion 33, an application execution control portion 34, an application storage portion 35, an application execution portion 36, and a data storage portion 37.

The scanner portion 21 generates image data by reading an image from the document, and is provided with an image scanner device employing, for example, a CCD (Charge Coupled Device). The scanner portion 21 operates according to an instruction from the MFP execution control portion 22, and writes the generated image data in the data storage portion 28. The scanner portion 21 writes the image data also in the data storage portion 37 of the PC 3 upon receipt of such a particular instruction from the MFP execution control portion 22. In the case of writing the image data in the data storage portion 37, the scanner portion 21 writes the image data under a specific file name to be identified as the image data written by the scanner portion 21.

The printing portion 23 prints an image on a recording sheet. The printing portion 23 operates according to an instruction from the MFP execution control portion 22, and thereby executes printing by reading out image data from the data storage portion 28 or the data storage portion 37 upon receipt of an instruction from the MFP execution control portion 22.

The MFP execution control portion 22 controls the MFP 2 to execute operations as the image forming apparatus (that is, scanning an image and printing an image). The MFP execution control portion 22 therefore controls the scanner portion 21 and the printing portion 23 according to an instruction from the workflow execution control portion 26.

The manipulation portion 27 enables the user to set the execution conditions and input an execution instruction in the MFP 2, and it is provided with, for example, a display and various kinds of manipulation keys.

The workflow storage portion 24 stores workflow information in which a workflow (the flow of operations to be executed by the MFP 2 and the PC 3) is written. The workflow storage portion 24 is able to store workflow information of more than workflow. The workflow information is written into the workflow storage portion 24 from the workflow registration control portion 31 via the network.

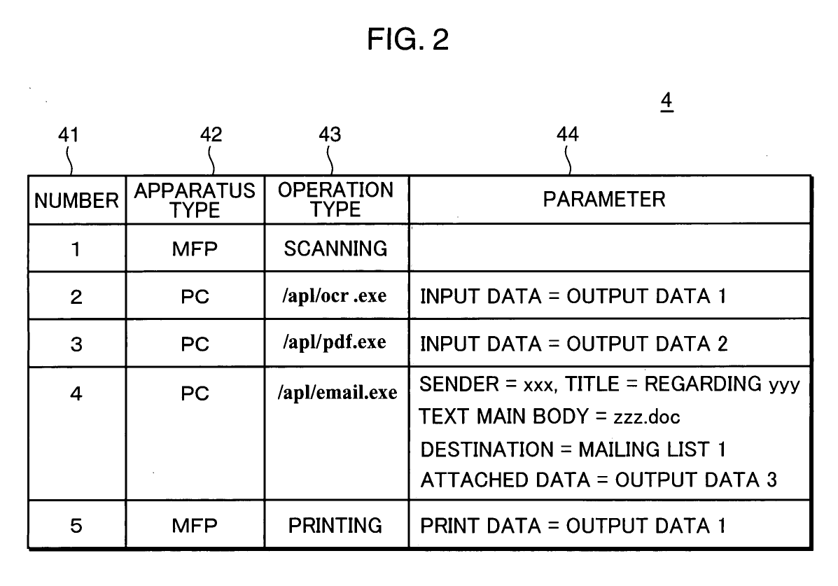

The workflow information will now be described briefly. FIG. 2 is a table showing one example of the workflow information. A series of operations to be executed sequentially (by the MFP 2 or the PC 3) is written as the workflow in workflow information 4. The operations include, on the MFP 2 side, copying, printing, and image scanning, and on the PC 3 side, execution of various application programs (for example, OCR (Optical Character Recognition) software, file format conversion (for example, conversion from TXT (text) to PDF (Portable Document Format) software) on the PC 3.

Execution operations are written row by row in the workflow information 4. A number column 41 is a column in which numbers indicating the execution sequence of respective execution operations are written (written in respective rows) Integers starting from “1” are assigned sequentially from the first row. These numbers are automatically assigned, for example, by the workflow generation assist portion 32. An apparatus type column 42 is a column in which the type of apparatus (for example, the MFP 2 or the PC 3) that executes each execution operation is written. An operation type column 43 is a column in which the type of execution operation to be executed by the MFP 2 or the PC 3 is written. The operation type includes, for example, scanning and printing on the MFP 2 side, and execution file names (including file paths to these files) of application programs on the PC 3 side.

A parameter column 44 is a column in which parameters for an operation specified by the operation type are written. The parameters written in this column are parameters needed to execute the operation specified in the operation type column 43, and include, for example, an argument needed when executing an application program, and the number of copies to be made by the MFP 2. In the parameter column 44, “output data (number)” can be written instead of writing the file name. This description means that data outputted by the operation written in the row whose number in the number column 41 coincides with (number) is used. The workflow execution control portion 26 replaces the “output data (number)”, for example, with a specific file name, and issues an instruction for the operation to the MFP execution control portion 22 or the application execution control portion 34.

Referring to FIG. 1 again, the workflow selection portion 25 selects the workflow information 4 of one workflow among the workflow information 4 of plural workflows stored in the workflow information storage portion 24. The workflow selection portion 25 selects the workflow specified by the user via the manipulation portion 27, and transfers the selected workflow to the workflow execution control portion 26. In this instance, the workflow selection portion 25 displays, for example, a list of the workflow information 4 of workflows stored in the workflow storage portion 24 (for example, a list of titles of the workflow information 4 of respective workflows) on the manipulation portion 27 to enable the user to select the desired one.

The workflow execution control portion 26 analyses the workflow information 4 transferred from the workflow selection portion 25, and performs control for operations written in the workflow information 4 to be executed in series (by the MFP 2 or the PC 3). The workflow execution control portion 26 therefore transmits the execution type (execution file name) and the parameters written in the workflow information 4 to the MFP execution control portion 22 or the application execution control portion 34.

The data storage portion 28 stores image data read by the scanner portion 21. The data is printed on a recording sheet by the printing portion 23.

The manipulation portion 33 is the user interface of the PC 3, and comprises, for example, a display, a keyboard, and a mouse.

The workflow generation assist portion 32 enables the user to generate the workflow information 4 with the use of the manipulation portion 33, and comprises, for example, an assistance tool. The workflow generation assist potion 32 is, for example, a program to input the workflow information 4.in a tabulated form, or a program to assist the user to generate the workflow information 4 using the GUI (Graphical User Interface). The workflow generation assist portion 32 is, for example, an application program. However, because the workflow generation support potion 32 is used for a specific purpose in the first embodiment, it is separated from the application execution portion 36 in the first embodiment.

The workflow registration control portion 31 writes the workflow information 4 generated in the workflow generation assist portion 32 in the workflow storage portion 24. The data storage portion 37 stores image data read by the scanner portion 21 and data generated in the application execution portion 36. The data stored therein is used by the application execution portion 36 or printed on a recording sheet by the printing portion 23.

The application storage potion 35 stores application programs to be executed by the PC 3, and comprises, for example, an HDD (Hard Disk Drive) The application execution portion 36 executes the application programs stored in the application storage portion 35, and is provided with, for example, a CPU (Central Processing Unit).

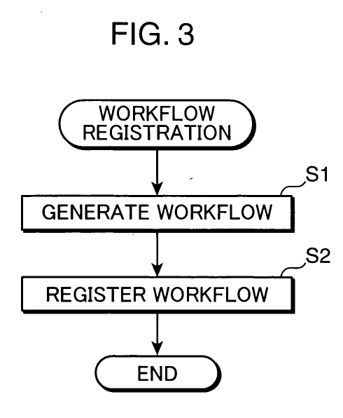

The flow of operations by the image forming system 1 of the first embodiment will now be described. FIG. 3 is a flowchart detailing the flow of operations for generation and registration of the workflow information 4.

In Step S1, the user generates the workflow information 4 on the PC 3 by manipulating the workflow generation assist portion 32 using the manipulation portion 33. In Step S2, the workflow registration control portion 31 (additionally) writes the workflow information 4 generated in Step S1 in the workflow storage portion 24 in the MFP 2 via the network.

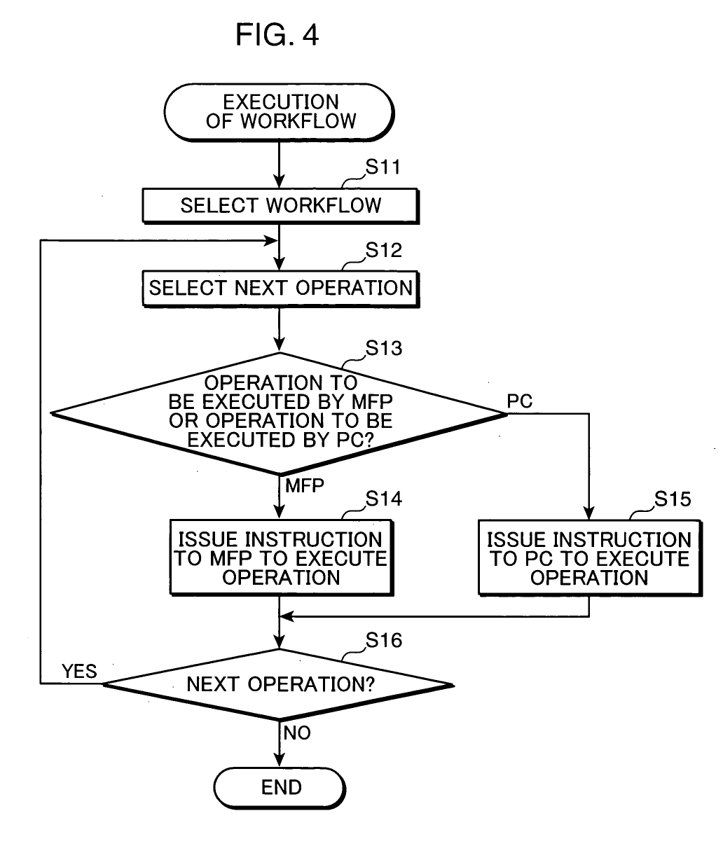

FIG. 4 is a flowchart detailing the flow of operations of the image forming system 1 when operations are executed using the workflow information 4.

In Step S11, the user selects the workflow information 4 of one workflow among the workflow information 4 of plural workflows stored in the workflow storage portion 24 by manipulating the workflow selection portion 25 using the manipulation portion 27 in the MFP 2. The workflow selection portion 25 then transmits the selected workflow information 4 to the workflow execution control portion 26.

In Step S12, the workflow execution control portion 26 selects a next unexecuted operation among operations written in the workflow information 4 received from the workflow selection portion 25. In Step S13, the workflow execution control portion 26 judges whether the selected operation is an operation to be executed by the MFP 2 or the operation to be executed by the PC 3 by referring to the apparatus type 42 in the workflow information 4. The flow proceeds to Step S14 when the operation is to be executed by the MFP 2 (branching denoted by MFP in Step S13). The flow proceeds to Step S15 when the operation is to be executed by the PC 3 (branching denoted by PC in Step S13).

In Step S14, the workflow execution control portion 26 transmits the operation type 43 and the parameter 44 of the selected operation (in the row of the selected operation in the workflow information 4) to the MFP execution control portion 22. Upon receipt of the transmission, the MFP execution control portion 22 controls the scanner portion 21 or the printing portion 23 to execute the selected operation. In Step S15, the workflow execution control portion 26 transmits the operation type 43 and the parameter 44 of the selected operation to the application execution control portion 34 of the PC 3. Upon receipt of the transmission, the application execution control portion 34 controls the application execution portion 36 to execute the selected operation.

When the processing in Step S14 ends or the processing in Step S15 ends, the flow proceeds to Step S16. In Step S16, the workflow execution control portion 26 checks whether there is any next unexecuted operation in the workflow information 4. When the presence of a next unexecuted operation is judged (YES in Step S16), the flow returns to Step S12; otherwise (NO in Step S16), the processing is terminated.

Operations of the image forming system 1 according to the concrete example of the workflow information 4 shown in FIG. 2 will now be described.

The workflow execution control portion 26 first transmits the operation type, “scanning”, to the MFP execution control portion 22 for the row having “1” in the number column 41. Upon receipt of the transmission, the MFP execution control potion 22 issues an instruction to the scanner portion 21 to execute image scanning and an instruction to the data storage portion 37 of the PC 3 to store the image data under a specific file name, for example, “/dat/_output001.bmp”. The scanner portion 21 then scans the image, and writes the image data thus read in the data storage portion 28 and in the data storage portion 37. The image data written in the data storage portion 37 is stored under the file name, for example, “_output001.bmp”.

Subsequently, for the row having “2” in the number column 41, the workflow execution control portion 26 transmits the execution file name, “/apl/ocr.exe” (execution file name of the OCR software”, and the argument, input data=“/dat/_output001.bmp” and output data =“/dat/_output002.txt”, to the application execution control portion 34. Upon receipt of the transmission, the application execution control portion 34 controls the application execution portion 36 to execute the OCR software using the argument specified above.

Subsequently, for the row having “3” in the number column 41, the workflow execution control portion 26 transmits the execution file name, “/apl/pdf.exe” (the execution file name of the software to convert a TXT file to a PDF file), and the argument, input data =“/dat/_output002.txt” and output data =“/dat/_output003.pdf”, to the application execution control portion 34. Upon receipt of the transmission, the application execution control portion 34 controls the application execution portion 36 to execute PDF conversion software using the argument specified above.

Subsequently, for the row having “4”, in the number column 41, the workflow execution control portion 26 transmits the execution file name, “/apl/email/exe” (the execution file name of the e-mail transmission software), and the argument, sender=xxx, title=regarding yyy, text main body=zzz.doc, destination=mailing list 1, and attached data “/dat/_output003.pdf”, to the application execution control portion 34. Upon receipt of the transmission, the application execution control portion 34 controls the application execution portion 36 to execute the e-mail transmission software using the argument specified above.

Subsequently, for the row having “5” in the number column 41, the workflow execution control portion 26 next transmits the operation type, “printing”, and a message indicating that data stored in the data storage portion 28 is used as the print data to the MFP execution control portion 22. Upon receipt of the transmission, the MFP execution control portion 22 issues an instruction to the printing portion 23 to execute printing of the image data stored in the data storage portion 28. The printing portion 23 thus prints the image data in the data storage portion 28 on a recording sheet.

As has been described, in the first embodiment, operations to be executed by the MFP 2 and the PC 3 written in the workflow information 4 are executed sequentially in the flow as the user merely selects the workflow information 4 stored in the workflow storage portion 24. The MFP 2 and the PC 3 are thus enabled to execute the flow of a series of operations at a time by merely giving a simple instruction to the MFP 2.

A second embodiment of the invention will now be described. In contrast to the first embodiment where the user generates the workflow information 4 on the PC 3 using the workflow generation assist portion 32, in the second embodiment, the workflow information 4 is generated by storing operations the user has performed using the MFP 2 and the PC 3 in the MFP 2. The workflow is executed in the same manner as in the first embodiment, and the description of the execution is omitted herein.

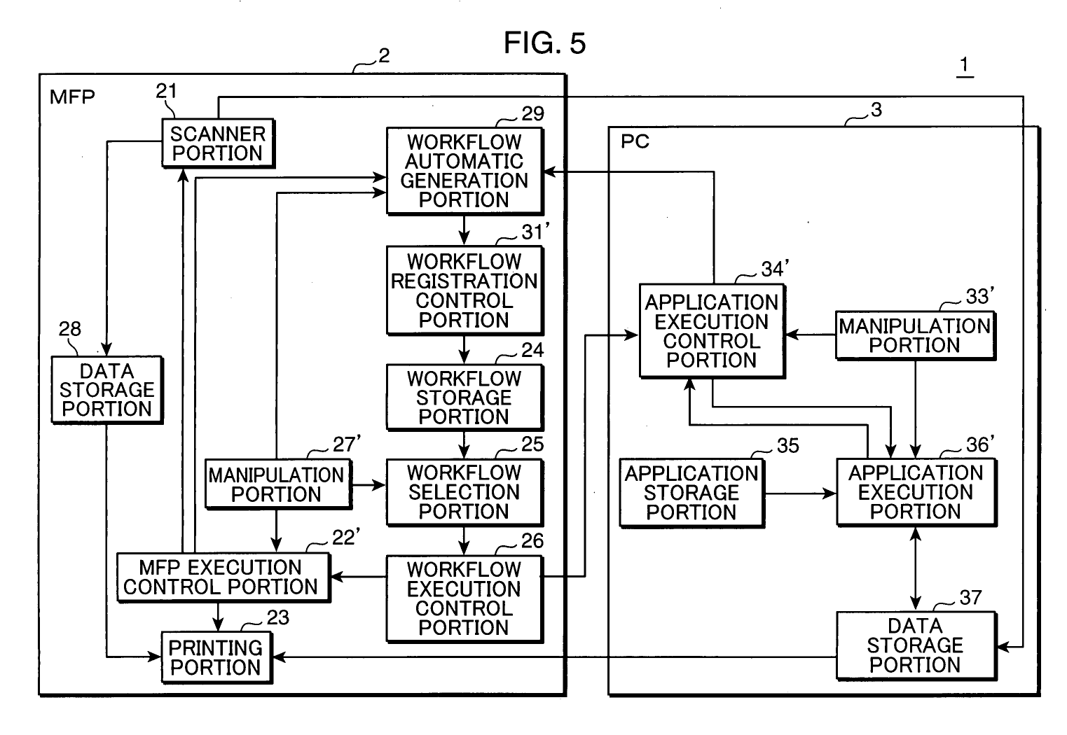

FIG. 5 is a block diagram showing the functional configuration of an image forming system 1 of the second embodiment. Like blocks are labeled with like reference numerals with respect to FIG. 1 of the first embodiment, and the description of such blocks is omitted herein, too.

In the MFP 2, a manipulation portion 27′, furnished with the function described in the first embodiment, also enables the user to input an execution instruction for an operation (image scanning, copying, etc.) to be executed by the MFP 2. The manipulation portion 27′ then transmits the input execution instruction to an MFP execution control portion 22′. Upon acceptance of a workflow automatic generation starting instruction or a workflow automatic generation ending instruction, the manipulation portion 27′ transmits a message indicating the acceptance to both the MFP execution control portion 22′ and a workflow automatic generation portion 29.

Upon receipt of the message indicating the acceptance of the workflow automatic generation starting instruction from the manipulation portion 27′, the MFP execution control portion 22′, furnished with the function described in the first embodiment, also starts to transmit an execution operation (described below) to the workflow automatic generation portion 29. Upon receipt of the message indicating the acceptance of the workflow automatic generation ending instruction, the MFP execution control portion 22′ ends the transmission of the execution operation to the workflow automatic generation portion 29.

In a case where the execution instruction of an operation to be executed by the MFP 2 is accepted from the manipulation portion 27′, the MFP execution control portion 22′ controls the scanner portion 21 and/or the printing portion 23 to execute the accepted operation. At the same time, the MFP execution control portion 22′ transmits the operation type and the parameter (execution condition) to the workflow automatic generation portion 29 (transmission of the execution operation).

In the PC 3, a manipulation portion 33′, furnished with the function described in the first embodiment, also enables the user to input an execution instruction of an operation to be executed by the PC 3 (execution of the application programs, etc.). The manipulation portion 33′ transmits the input execution instruction to an application execution portion 36′. Upon acceptance of the workflow automatic generation starting instruction and the workflow automatic generation ending instruction, the manipulation portion 33′ transmits a message indicating the acceptance to an application execution control portion 34′.

When the application execution portion 36′, furnished with the function described in the first embodiment, also executes the application according to an instruction from the manipulation portion 33′, the application execution portion 36′ transmits the execution file name and the execution parameter of the application to be executed to the application execution control portion 34′.

Upon receipt of the message indicating the acceptance of the workflow automatic generation starting instruction from the manipulation portion 33′, the application execution control portion 34′, furnished with the function described in the first embodiment, also starts to transmit the execution operation (described below) to the workflow automatic generation portion 29. Upon receipt of the message indicating the acceptance of the workflow automatic generation ending instruction, the application execution control portion 34′ ends the transmission of the execution operation to the workflow automatic generation portion 29.

Upon receipt of the execution file name and the execution parameter from the application execution portion 36′, the application execution control portion 34′ transmits these execution file name and execution parameter to the workflow automatic generation portion 29 (transmission of the execution operation).

In the MFP 2, upon receipt of the message indicating the acceptance of the workflow automatic generation starting instruction from the manipulation portion 27′, the workflow automatic generation portion 29 starts to generate the workflow information 4, and adds the operation type (execution file name) and the parameter received from the MFP execution control portion 22′ or the application execution control portion 34′ as a new row in the workflow information 4. Upon receipt of the message indicating the acceptance of the workflow automatic generation ending instruction from the manipulation portion 27′, the workflow automatic generation portion 29 ends the generation of the workflow information 4, and transmits the workflow information 4 thus generated to a workflow registration control portion 31′.

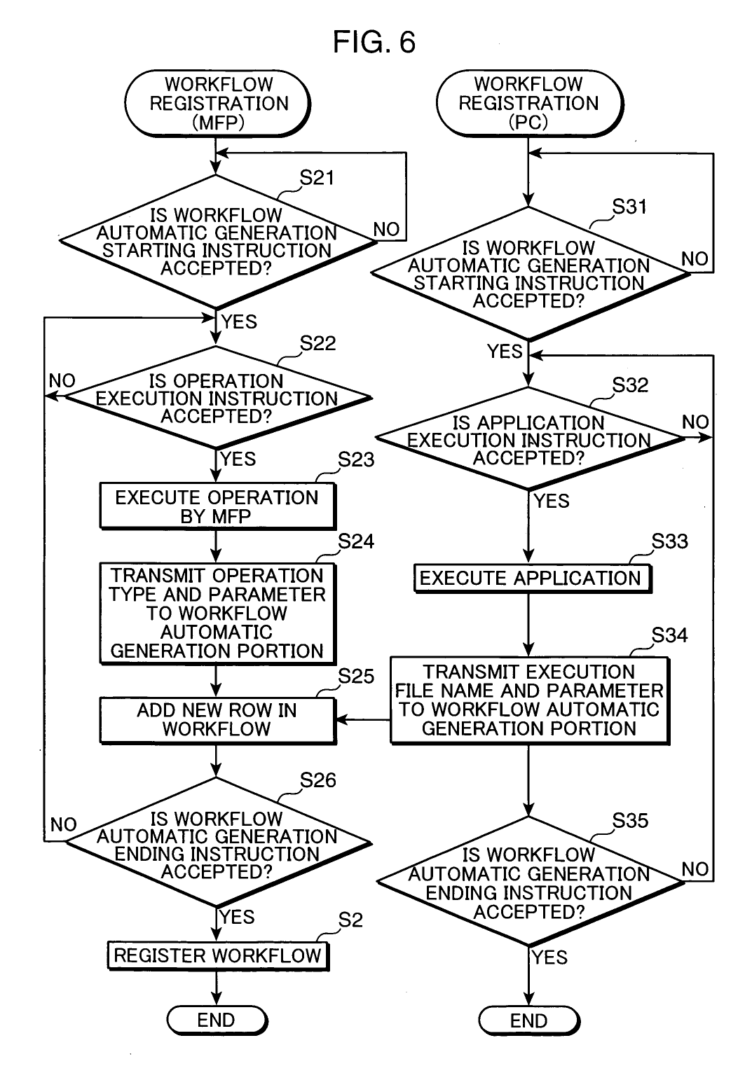

The flow of the generation and registration of the workflow in the second embodiment will now be described. FIG. 6 is a flowchart detailing the flow of the generation and registration of the workflow to be implemented by the image forming system 1 of the second embodiment.

In the MFP 2, in Step S21, the manipulation portion 27′ checks whether an input of the workflow automatic generation starting instruction made by the user is accepted until the acceptance is judged (NO in Step S21). Upon acceptance of the input (YES in Step S21), the manipulation portion 27′ transmits a message indicating the acceptance to both the MFP execution control portion 22′ and the workflow automatic generation portion 29. Upon receipt of the transmission, the MFP execution control portion 22′ starts to transmit the operation type and the parameter to the workflow automatic generation portion 29 whereas the workflow automatic generation portion 29 starts to generate the workflow information 4. The flow then proceeds to Step S22. In Step S22, the manipulation portion 27′ checks whether an input of the execution instruction of the operation to be executed by the MFP 2 made by the user is accepted until the acceptance is judged (NO in Step S22). Upon acceptance of the input of the execution instruction of the operation to be executed by the MFP 2 (YES in Step S22), the manipulation portion 27′ transmits a message indicating the acceptance to the MFP execution control portion 22′. The flow then proceeds to Step S23.

In Step S23, the MFP execution control portion 22′ controls the scanner portion 21 and/or the printing portion 23 to execute the execution operation received from the manipulation portion 27′. In Step S24, the MFP execution control portion 22′ transmits the operation content (operation type and parameter) received from the manipulation portion 27′ to the workflow automatic generation portion 29. In Step S25, the workflow automatic generation portion 29 adds the operation content received from the MFP execution control portion 22′ as a new row in the workflow information 4.

In Step S26, the manipulation portion 27′ checks whether an input of the workflow automatic generation ending instruction made by the user is accepted. In the case of non-acceptance (NO in Step S26), the flow returns to Step S22 and the processing is repeated from Step S22. Upon acceptance of the workflow automatic generation ending instruction (YES in Step S26), the flow proceeds to Step S2.

Meanwhile, in the PC 3, in Step S31, the manipulation portion 33′ checks whether an input of the workflow automatic generation starting instruction made by the user is accepted until the acceptance is judged (NO in Step S31). Upon acceptance of the input (YES in Step S31), the manipulation portion 33′ transmits a message indicating the acceptance to the application execution control portion 34′. Upon receipt of the transmission, the application execution control portion 34′ starts to transmit the operation type (execution file name) and the parameter to the workflow automatic generation portion 29. The flow then proceeds to Step S32. In Step S32, the manipulation portion 33′ checks whether an input of the execution instruction of the application made by the user is accepted until the acceptance is judged (NO in Step S32). Upon acceptance of the input of the execution instruction of the application (YES in Step S32), the manipulation portion 33′ transmits a message indicating the acceptance to the application execution portion 36′. The flow then proceeds to Step S33.

In Step S33, the application execution portion 36′ executes the file under the file name received from the manipulation portion 33′, and transmits the file name and the parameter to the application execution control portion 34′. In Step S34, the application execution control portion 34′ transmits the file name and the parameter received from the application execution portion 36′ to the workflow automatic generation portion 29 in the MFP 2. In Step S35, the manipulation portion 33′ checks whether an input of the workflow automatic generation ending instruction made by the user is accepted. In the case of non-acceptance (NO in Step S35), the flow returns to Step S32 and the processing is repeated from. Step S32. Upon acceptance of the workflow automatic generation ending instruction (YES in Step S35), the processing of the generation and registration of the workflow is terminated.

As has been described, in the second embodiment, the flow of operations is stored as the workflow information 4 without the need for the user to generate the workflow information 4 as the user performs a series of operations by the MFP 2 and the PC 3. The user therefore does not have to perform complicated manipulation to generate the workflow information 4.

It should be appreciated that the invention is not limited to the embodiments above, and embodiments as described below are also applicable. In the first embodiment, both the workflow generation assist portion 32 and the workflow registration control portion 31 are provided to the PC 3; however, both may be provided to the MFP 2 or one may be provided to the PC 3 and the other to the MFP 2. Also, in the second embodiment, both the workflow automatic generation portion 29 and the workflow registration control portion 31′ are provided to the MFP 2; however, both may be provided to the PC 3, or one may be provided to the PC 3 and the other to the MFP 2.

In the first embodiment, the list of the workflows is displayed on the manipulation portion 27 to enable the user to select one workflow; however, a specific workflow may be pre-assigned to a button, so that the user is able to select the workflow by merely depressing the button (that is, one-button control).

In the second embodiment, the user gives the workflow automatic generation starting instruction and the automatic generation ending instruction to both the MFP 2 and the PC 3. However, the user may give the instructions to either one apparatus (for example, the MFP 2) alone by configuring in such a manner that the instructions are transmitted from one-apparatus (for example, the MFP 2) to the other apparatus. (for example, the PC 3).

In the second embodiment, the execution file name and the parameter of the application program to be executed by the application execution portion 36′ are transmitted to the application execution control portion 34′. However, the application execution control portion 34′ may acquire the execution file name and the parameter of the application program to be executed directly from the application execution portion 36′.

In conclusion, the invention provides an image forming system including an image forming apparatus and an information processing apparatus connected to each other via a telecommunication line. The image forming apparatus includes: a workflow storage portion that stores workflow information in which types and a sequence of operations to be executed by the image forming apparatus and the information processing apparatus are written; a selection portion that enables a user to select workflow information of one workflow among the workflow information of plural workflows stored in the workflow storage portion; a workflow execution control portion that issues an instruction to each of the image forming apparatus and the information processing apparatus to execute operations written in the workflow information selected by the selection portion; and an image formation execution control portion that controls the image forming apparatus to operate according the instruction from the workflow execution control, portion. The information processing apparatus includes: an application storage portion that stores various application programs executable on the information processing apparatus; an application execution portion that executes the application programs stored in the application storage portion; and an application execution control portion that controls the application execution portion to execute the application programs stored in the application storage portion according to the instruction from the workflow execution control portion.

When configured in this manner, the image forming apparatus and the information processing apparatus are enabled to execute the flow of a series of operations at a time by merely giving a simple instruction to the image forming apparatus.

The image forming system of the invention may be configured in such manner that the image forming apparatus further includes an image read portion that reads an image on a document in a form of image data and an image forming portion that forms the image on a recording sheet, and that the image formation execution control portion controls at least one of the image read portion and the image forming portion to operate according to the instruction from the workflow execution control portion.

Also, the image forming system of the invention may be configured in such a manner that at least one of the image forming apparatus and the information processing apparatus further includes a workflow generation portion that enables the user to generate the workflow information, and a workflow registration portion that stores the workflow information generated by the workflow generation portion in the workflow storage portion.

When configured in this manner the image forming apparatus and the information processing apparatus are enabled to execute the flow of a series of operations at a time by merely giving a simple instruction to the image forming apparatus.

The image forming system of the invention may be configured as follows: the image forming apparatus further includes an image formation execution instruction acceptance portion that accepts a selection and an execution instruction made by the user for operations to be executed by the image forming apparatus, and the image formation execution control portion controls the image forming apparatus to operate according to the selection and the execution instruction accepted by the image formation execution instruction acceptance portion; the information processing apparatus further includes an application execution instruction acceptance portion that accepts a selection and an execution instruction made by the user for the application programs to be executed by the information processing apparatus, and the application execution portion executes selected application programs according to the selection and the execution instruction accepted by the application execution instruction acceptance portion; and one of the image forming apparatus and the information processing apparatus further includes a workflow automatic generation portion that acquires operations to be executed by the image forming apparatus and the information processing apparatus from the image formation execution control portion and the application execution portion and generates the workflow information according to the acquired operations, and a workflow automatic registration portion that stores the workflow information generated by the workflow automatic generation portion in the workflow storage portion.

When configured in this manner, the workflow information is generated automatically by actually making the image forming apparatus and the information processing apparatus execute the flow of a series of operations the user wishes to perform on the image information apparatus and the information processing apparatus. The workflow information can be therefore generated and registered with ease.

The invention also provides an image forming apparatus, including: a workflow storage portion that stores workflow information in which types and a sequence of operations to be executed by the image forming apparatus and an information processing apparatus connected to the image forming apparatus via a telecommunication line are written; a selection portion that enables a user to select workflow information of one workflow among the workflow information of plural workflows stored in the workflow storage portion; a workflow execution control portion that issues an instruction to each of the image forming apparatus and the information processing apparatus to execute operations written in the workflow information selected by the selection portion; and an image formation execution control portion that controls the imaging forming apparatus to operate according to the instruction from the workflow execution control portion.

The invention further provides a recording medium having stored a control program that causes a computer provided to an image forming apparatus to function as portions as follows: a selection and acceptance portion that accepts an input made by a user to select workflow information of one workflow among the workflow information of plural workflows, in each of which types and a sequence of operations to be executed by the image forming apparatus and an information processing apparatus connected to the image forming apparatus via a telecommunication line are written; a workflow execution control portion that issues an instruction to each of the image forming apparatus and the information processing apparatus to execute operations written in the workflow information selected and accepted by the selection and acceptance portion; and an image formation execution control portion that controls the image forming apparatus to operate according to the instruction from the workflow execution control portion.

When configured in this manner, the image forming apparatus and the information processing apparatus are enabled to execute the flow of a series of operations at a time by merely giving a simple instruction to the image forming apparatus.

The invention further provides an information processing apparatus, including: an application storage portion that stores various application programs executable on the information processing apparatus; an application execution portion that executes the application programs stored in the application storage portion; and an application execution control portion that controls the application execution portion to execute the application programs stored in the application storage portion according to an instruction from an image forming apparatus connected to the information processing apparatus via a telecommunication line.

When configured in this manner, the image forming apparatus and the information processing apparatus are enabled to execute the flow of a series of operations at a time by merely giving a simple instruction to the image forming apparatus.

This application is based on Japanese Patent Application No. 2004-372223 filed on Dec. 22, 2004, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming system comprising an image forming apparatus and an information processing apparatus connected to each other via a telecommunication line, wherein the image forming apparatus includes:
a workflow storage portion that stores workflow information in which types and a sequence of operations to be executed by the image forming apparatus and the information processing apparatus are written;
a selection portion that enables a user to select workflow information of one workflow among the workflow information of plural workflows stored in the workflow storage portion;
a workflow execution control portion that issues an instruction to each of the image forming apparatus and the information processing apparatus to execute operations written in the workflow information selected by the selection portion; and
an image formation execution control portion that controls the image forming apparatus to operate according the instruction from the workflow execution control portion, and wherein the information processing apparatus includes:
an application storage portion that stores various application programs executable on the information processing apparatus;
an application execution portion that executes the application programs stored in the application storage portion; and
an application execution control portion that controls the application execution portion to execute the application programs stored in the application storage portion according to the instruction from the workflow execution control portion.

2. The image forming system according to claim 1, wherein the image forming apparatus further includes:
an image read portion that reads an image on a document in a form of image data; and
an image forming portion that forms the image on a recording sheet, and wherein:
the image formation execution control portion controls at least one of the image read portion and the image forming portion to operate according to the instruction from the workflow execution control portion.

3. The image forming system according to claim 2, wherein at least one of the image forming apparatus and the information processing apparatus further includes:
a workflow generation portion that enables the user to generate the workflow information; and
a workflow registration portion that stores the workflow information generated by the workflow generation portion in the workflow storage portion.

4. The image forming system according to claim 2,
wherein the image forming apparatus further includes an image formation execution instruction acceptance portion that accepts a selection and an execution instruction made by the user for operations to be executed by the image forming apparatus, and the image formation execution control portion controls the image forming apparatus according to the selection and the execution instruction accepted by the image formation execution instruction acceptance portion;
wherein the information processing apparatus further includes an application execution instruction acceptance portion that accepts a selection and an execution instruction made by the user for the application programs to be executed by the information processing apparatus, and the application execution portion executes selected application programs according to the selection and the execution instruction accepted by the application execution instruction acceptance portion; and
wherein one of the image forming apparatus and the information processing apparatus further includes,
a workflow automatic generation portion that acquires operations to be′ executed by the image forming apparatus and the information processing apparatus from the image formation execution control portion and the application execution portion, and generates the workflow information according to the acquired operations, and
a workflow automatic registration portion that stores the workflow information generated by the workflow automatic generation portion in the workflow storage portion.

5. The image forming system according to claim 1, wherein at least one of the image forming apparatus and the information processing apparatus further includes:
a workflow generation portion that enables the user to generate the workflow information; and
a workflow registration portion that stores the workflow information generated by the workflow generation portion in the workflow storage portion.

6. The image forming system according to claim 5,
wherein the image forming apparatus further includes an image formation execution instruction acceptance portion that accepts a selection and an execution instruction made by the user for operations to be executed by the image forming apparatus, and the image formation execution control portion controls the image forming apparatus according to the selection and the execution instruction accepted by the image formation execution instruction acceptance portion;
wherein the information processing apparatus further includes an application execution instruction acceptance portion that accepts a selection and an execution instruction made by the user for the application programs to be executed by the information processing apparatus, and the application execution portion executes selected application programs according to the selection and the execution instruction accepted by the application execution instruction acceptance portion; and
wherein one of the image forming apparatus and the information processing apparatus further includes,
a workflow automatic generation portion that acquires operations to be executed by the image forming apparatus and the information processing apparatus from the image formation execution control portion and the application execution portion, and generates the workflow information according to the acquired operations, and
a workflow automatic registration portion that stores the workflow information generated by the workflow automatic generation portion in the workflow storage portion.

7. The image forming system according to claim 1,
wherein the image forming apparatus further includes an image formation execution instruction acceptance portion that accepts a selection and an execution instruction made by the user for operations to be executed by the image forming apparatus, and the image formation execution control portion controls the image forming apparatus according to the selection and the execution instruction accepted by the image formation execution instruction acceptance portion;
wherein the information processing apparatus further includes an application execution instruction acceptance portion that accepts a selection and an execution instruction made by the user for the application programs to be executed by the information processing apparatus, and the application execution portion executes selected application programs according to the selection and the execution instruction accepted by the application execution instruction acceptance portion; and
wherein one of the image forming apparatus and the information processing apparatus further includes,
a workflow automatic generation portion that acquires operations to be executed by the image forming apparatus and the information processing apparatus from the image formation execution control portion and the application execution portion, and generates the workflow information according to the acquired operations, and
a workflow automatic registration portion that stores the workflow information generated by the workflow automatic generation portion in the workflow storage portion.

8. An image forming apparatus, comprising:
a workflow storage portion that stores workflow information in which types and a sequence of operations to be executed by the image forming apparatus and an information processing apparatus connected to the image forming apparatus via a telecommunication line are written;
a selection portion that enables a user to select workflow information of one workflow among the workflow information of plural workflows stored in the workflow storage portion;
a workflow execution control portion that issues an instruction to each of the image forming apparatus and the information processing apparatus to execute operations written in the workflow information selected by the selection portion; and
an image formation execution control portion that controls the imaging forming apparatus to operate according to the instruction from the workflow execution control portion.

9. An information processing apparatus, comprising:
an application storage portion that stores various application programs executable on the information processing apparatus;
an application execution portion that executes the application programs stored in the application storage portion; and
an application execution control portion that controls the application execution portion to execute the application programs stored in the application storage portion according to an instruction from an image forming apparatus connected to the information processing apparatus via a telecommunication line.

10. A recording medium having stored a control program that causes a computer provided to an image forming apparatus to function as portions as follows:
a selection and acceptance portion that accepts an input made by a user to select workflow information of one workflow among the workflow information of plural workflows, in each of which types and a sequence of operations to be executed by the image forming apparatus and an information processing apparatus connected to the image forming apparatus via a telecommunication line are written;
a workflow execution control portion that issues an instruction to each of the image forming apparatus and the information processing apparatus to execute operations written in the workflow information selected and accepted by the selection and acceptance portion; and
an image formation execution control portion that controls the image forming apparatus to operate according to the instruction from the workflow execution control portion.
